(19) United States
(12) Patent Application Publication
(10) Pub. No.: US 2014/0149877 A1
(43) Pub. Date: May 29, 2014

(54) METHOD AND TERMINAL DEVICE FOR DISPLAYING PUSH MESSAGE

(71) Applicant: Xiaomi Inc., Beijing (CN)

(72) Inventors: Bin Wang, Beijing (CN); Daokuan Liu, Beijing (CN); Xuanran Wang, Beijing (CN); Tingbin Wu, Beijing (CN); Jinliang Ou, Beijing (CN)

(73) Assignee: Xiaomi Inc., Beijing (CN)

(21) Appl. No.: 14/103,807

(22) Filed: Dec. 11, 2013

Related U.S. Application Data
(63) Continuation-in-part of application No. PCT/CN2013/084111, filed on Sep. 24, 2013.

(30) Foreign Application Priority Data
Oct. 31, 2012 (CN) 201210429458.X

(51) Int. Cl. G06F 3/0484; H04L 29/08

(52) U.S. Cl. CPC G06F 3/0484; H04L 67/02
USPC 715/738; 709/219

(57) ABSTRACT

The present disclosure discloses a method and a terminal device for displaying a push message, wherein the method comprises steps of detecting a triggering event for loading a new content; determining whether a blank loading area exists on a current display page for loading the new content; and, if the blank loading area exists on the current display page, displaying the push message in the blank loading area. In the present disclosure, the display resources of a terminal device can be sufficiently utilized by displaying push message when the loading page is blank, so that a user can acquire various types of information without performing tedious operations, thereby simplifying user operations.

### CROSS-REFERENCE TO RELATED APPLICATIONS

This application is a Continuation-In-Part of International Application PCT/CN2013/084111, with an international filing date of Sep. 24, 2013, which claims priority to Chinese Patent Application No. 201210429458.X, filed on Oct. 31, 2012, both of which are hereby incorporated by reference in their entireties.

### TECHNICAL FIELD

The present disclosure generally relates to network technology field, and more particularly, to a method and terminal device for displaying a push message.

### BACKGROUND

With the rapid development of Internet network and the prevalence of networkable terminal devices, the networkable terminal devices are more and more used for acquiring a large amount of information. For example, the news may be acquired by visiting a website via a browser, and weather information may be acquired from a network via a designated application configured in a client device.

Accordingly, when intending to browse different types of information using a terminal device, a user has to initiate a specific application in the device for viewing the corresponding information. Thus, the user is required to perform tedious operations if he/she wishes to acquire different types of information.

### SUMMARY

The present disclosure provides a method and terminal device for displaying a push message, through which the push message can be displayed on a terminal device, so that a user may obtain various types of information without performing tedious operations, thereby simplifying user operations.

According to an aspect of the present disclosure, a method for displaying a push message comprises: detecting a triggering event for loading a new content; determining whether a blank loading area exists on a current display page for loading the new content; and, if the blank loading area exists on the current display page, displaying the push message in the blank loading area.

According to another aspect of the present disclosure, a terminal device comprises: a processor; and a memory for storing instructions executable by the processor; wherein the processor is configured to execute steps comprising: detecting a triggering event for loading a new content; determining whether a blank loading area exists on a current display page for loading the new content; and if the blank loading area exists on the current display page, displaying the push message in the blank loading area.

According to another aspect of the present disclosure, a non-transitory computer readable storage medium, which stores instructions which when executed perform a method in a terminal device, the method comprising: detecting a triggering event for loading a new content; determining whether a blank loading area exists on a current display page for loading the new content; and if the blank loading area exists on the current display page, displaying the push message in the blank loading area.

Other features and advantages of the present disclosure will be illustrated in the description hereinafter, and will become apparent from the description or through the implementation of the present disclosure. The purposes and other advantages of the present disclosure may be achieved and obtained by specific structures listed in the description, the claims, and the accompanying drawings.

It should be understood that the descriptions above in general and hereinafter in detail are only for illustrative but not to limit the present disclosure.

Further detailed descriptions of the present disclosure will be illustrated with reference to the accompanying drawings and the embodiments.

### BRIEF DESCRIPTION OF THE DRAWINGS

The accompanying drawings are used to provide further illustration of the present disclosure, and constitute a part of the description, rather than limiting the present disclosure, wherein,

FIG. 1 is an illustrative flow chart of a method for displaying a push message according to some embodiments of the present disclosure;

FIG. 2 is an illustrative flow chart of a method for displaying a push message according to a first embodiment of the present disclosure;

FIG. 3 is an illustrative flow chart of a method for displaying a push message according to a second embodiment of the present disclosure;

FIG. 4 is an illustrative flow chart of a method for displaying a push message according to the third embodiment of the present disclosure;

FIG. 5 is an illustrative flow chart of a method for displaying a push message according to the fourth embodiment of the present disclosure;

FIG. 6 is an illustrative flow chart of a method for displaying a push message according to the fifth embodiment of the present disclosure;

FIG. 7 is an illustrative block diagram of an apparatus for displaying a push message according to some embodiments of the present disclosure.

Specific embodiments of the present disclosure have been illustrated in the above drawings and the detailed description thereof will be given hereinafter. These drawings and written description are only to illustrate the concept of the present disclosure with reference to the specific embodiments for those skilled in the art rather than limiting the scope conceived by the present disclosure in any manner.

### DESCRIPTION OF THE EMBODIMENTS

The embodiments of the present disclosure will be explained with reference to the accompanying drawings. It should be understood that the embodiments described herein are only used to illustrate and explain the present disclosure, but not to limit the present disclosure.

A user may open an application with network function in a networkable terminal device such as a mobile telephone, a tablet, and other device which is provided with a touch screen. When the user intends to refresh content displayed in the application, he/she may drag a current interface down by finger(s) to refresh, that is, to load a new content, which greatly facilitates the refresh operation of the user.

When such a drag-down-to-refresh manner is utilized, the current interface displayed in the terminal device may move downwards along with the dragging of finger(s), so that the top part of the display may become blank and serve as a loading area for the new content. When the terminal device finishes loading the new content requested by the user from a server, the new content may be displayed in the blank loading area. However, before the new content is completely loaded, the loading area is kept blank.

The blank loading area described above is utilized in the present disclosure to display a push message for a user's terminal device. A push message is a message containing certain information that is directly pushed to a client without any client operation. For example, when an application of a user has an incoming event, such as a new email is received in the Email application, the event is directly pushed to the user as one kind of push messages, and the user does not need to open the application or periodically log into the application to check whether a new event has occurred.

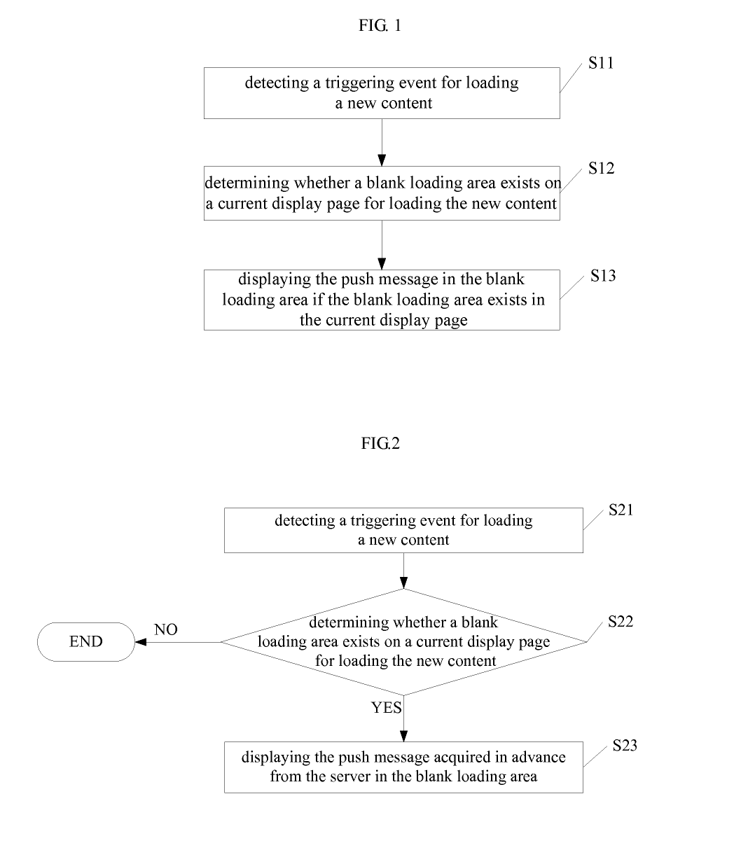

As shown in FIG. 1, it illustrates a method for displaying a push message according to some embodiments of the present disclosure. The method includes the following steps.

In step S11, a triggering event for loading a new content is detected.

In step S12, whether a blank loading area exists on a current display page for loading the new content is determined.

In step S13, if the blank loading area exists on the current display page, the push message in the blank loading area is displayed.

The present disclosure can display the push message on the blank loading area on the display page, which appears when the terminal device is loading a new content, so that display resources of the terminal device may be sufficiently utilized, and a user can acquire various types of information without performing any tedious operation, thereby simplifying user operations. The push message may include product advertisements, weather information or other contents. Such a displaying manner can make best use of the limited display area of the device without affecting the convenience and efficiency of user operation, thereby enhance the exhibition of various contents to the user.

Hereinafter, the method for displaying a push message according to the present disclosure will be described in detail through other embodiments.

FIG. 2 is an illustrative flow chart of a method for displaying a push message according to a first embodiment of the present disclosure. As shown in FIG. 2, a push message acquired in advance from a server is taken as an example to illustrate the method for displaying a push message according to the present disclosure. Accordingly, the embodiment may include a step, which may be performed in advance, of recieving a push message delivered by a server.

The step may be performed periodically or set to be performed only when a terminal device is connected to a network.

Further, the push information delivered initiatively by the server may be filtered according to subscription messages set by a user. For example, it is determined whether the push message contains any message subscribed by a user, and if so, the message subscribed by the user contained in the push message may be stored as the push message acquired in advance.

When an event for loading a new content is triggered, the method for displaying a push message according to the first embodiment of the present disclosure includes step S21 to detect a triggering event for loading a new content.

Currently, the triggering event for loading the new content may usually refer to an operation of dragging down/up the current display page, so as to load the new content, or may refer to clicking a button by a user to acquire the new content, or may also refer to loading the new content automatically while running a certain application.

In step S22, it is determined whether a blank loading area exists on a current display page for loading the new content. If it is determined that the blank loading area exists on the current display page, the method proceeds to step S23 to display the push message acquired in advance from a server in the blank loading area.

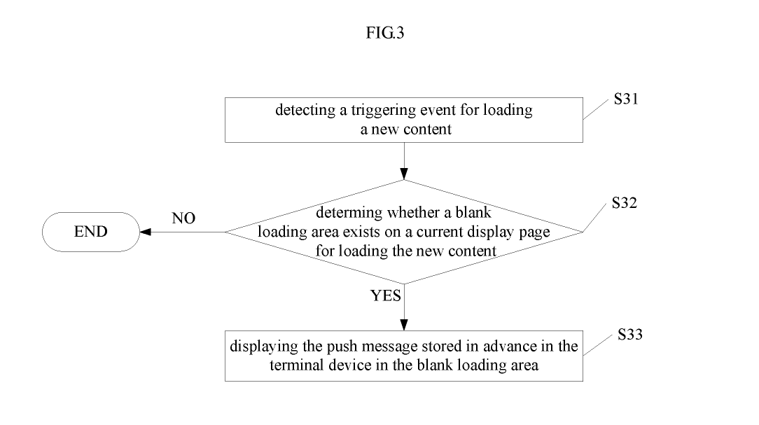

FIG. 3 is an illustrative flow chart of a method for displaying a push message according to a second embodiment of the present disclosure. As shown in FIG. 3, a push message preset in a terminal device is taken as an example to illustrate the method for displaying a push message according to the present disclosure. Accordingly, the embodiment may include a step, which may be performed in advance, of storing a push message in the terminal device in advance according to user settings or device operator settings.

When an event for loading a new content is triggered, the method for displaying a push message according to the second embodiment the present disclosure includes the following steps.

In step S31, a triggering event for loading a new content is detected. In step S32, it is determined whether a blank loading area exists on a current display page for loading the new content. If it is determined that the blank loading area exists on the current display page, the method proceeds to step S33 to display in the blank loading area the push message stored in advance in the terminal device.

As the method for displaying a push message provided in the present embodiment, it may be implemented without any communication with the server.

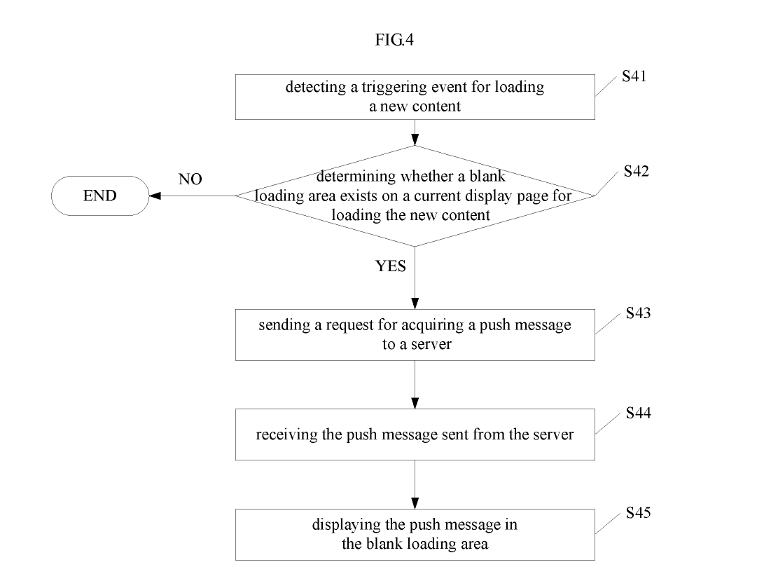

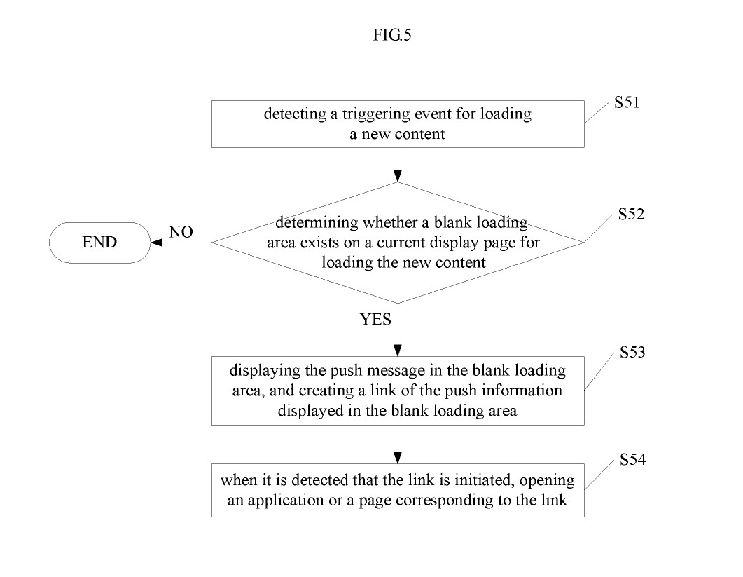

FIG. 4 is an illustrative flow chart of a method for displaying a push message according to a third embodiment of the present disclosure. As shown in FIG. 4, a case in which a terminal device requests a server for a push message in real time is taken as an example to illustate the method for displaying a push message according to the present disclosure.

Accordingly, the embodiment includes the following steps. In step S41, a triggering event for loading a new content is detected. In step S42, it is determined whether a blank loading area exists on a current display page for loading the new content. If it is determined that the blank loading area exists on the current display page, the method proceeding to a step S43 to send a request for acquiring a push message to the server.

In some exemplary embodiments, the request may include an message subscribed by a user, so that the server may deliver a corresponding push message according to the subscribed message; or, the server may deliver a corresponding push message according to a user information stored in advance in the server.

After sending a request for acquiring a push message to the server, the networkalbe device receives the push message delivered by the server in step S44 and displays the push message in the blank loading area in step S45.

FIG. 5 is an illustrative flow chart of a method for displaying a push message according to a fourth embodiment of the present disclosure. As shown in FIG. 5, the present disclosure provides a method for displaying a push message, which not only displays the push message in a blank loading area but also creates a link of the push message. Referring to FIG. 5, the method includes the following steps. In step S51, a triggering event for loading a new content is detected. In step S52, it is determined whether a blank loading area exists on a current display page for loading the new content. If it is determined that the blank loading area exists on the current display page, the method proceeds to step S53. Otherwise the process ends.

Then, in step S53, a push informaton is displayed in the blank loading area and a link of the push message displayed in the blank loading area is created.

In some exemplary embodiments, when it is detected that the link is initiated, the method futher includes an operation of opening an application or a page corresponding to the link in step S54.

For example, when an update information for a certain application is contained in the push message, the information may be clicked directly to open the corresponding applciation to perform the update, which further facilitates user operation.

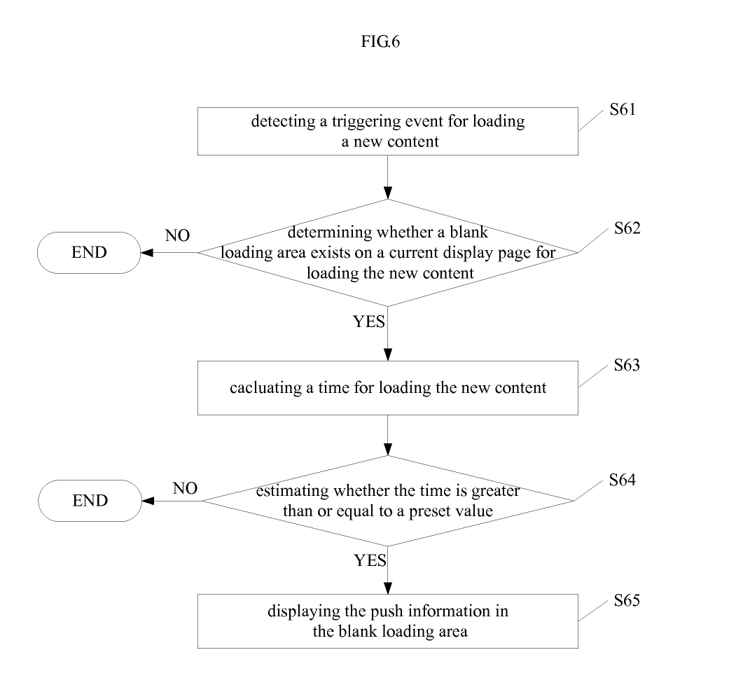

FIG. 6 is an illustrative flow chart of a method for displaying a push message according to a fifth embodiment of the present disclosure. As shown in FIG. 6, it illustrates a method for displaying a push message according to the present disclosure, which includes a step of estimating a time for loading a new content on the basis of the above embodiments. According to the fifth embodiment of the present disclosure, the push message may be displayed only if a preset value is satisfied, so that the display of the push message may become more reasonable. The preset value can be a default value set in the terminal device that has been tested to be most suitable duration for viewing the push message or a user may choose to configure his/her own value.

Accordingly, the embodiment may include the following steps. In step S61, a triggering event for loading a new content is detected. In step S62, it is determinded whether a blank loading area exists on a current display page for loading the new content. If it is determined that the blank loading area exists on the current display page, the method proceeds to step S63. Otherwise, the process ends.

In Step S63, a time for loading the new content is calculated. In some exemplary embodiments, the time for loading the new content may be cacluated according to the loading condition of a network and the loading size of the new content.

In step S64, it is estimated whether the time is greater than or equal to a preset value. If the time is greater than or equal to the preset value, the method proceeds to step S65, otherwise the process ends.

In step S65, the push message in the blank loading area is displayed.

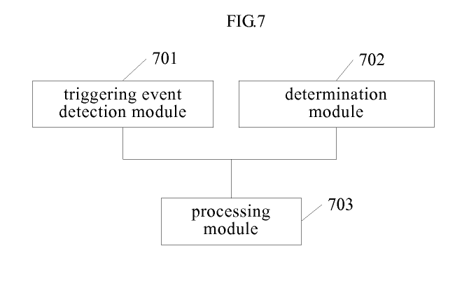

FIG. 7 is an illustrative block diagram of an apparatus for displaying a push message according to some embodiments of the present disclosure. As shown in FIG. 7, the present disclosure provides an apparatus for displaying a push message. The apparatus includes: a triggering event detection module 701, a determination module 702 and a processing module 703.

The triggering event detection module 701 is configured to detect a triggering event for loading a new content.

The determination module 702 is configured to determine whether a blank loading area exists on a current display page for loading the new content after the triggering event detection module detects the triggering event.

The processing module 703 is configured to, if the blank loading area exists on the current display page, display the push message in the blank loading area.

For example, the processing module 703 may display a push message received in real time or repeatedly delivered by a server, as the push message to be displayed in the blank loading area, or may use a push message stored locally in advance as the push message to be displayed in the blank loading area.

The processing module 703 may be further configured to determine whether the push message delivered by the server contains any message subscribed by a user, and, if so, using the message subscribed by the user as the push message to be displayed in the blank loading area.

For example, if the blank loading area exists on the current display page, the processing module 703 may be further configured to send a request for acquiring a push message to a server, and receive the push message delivered by the server.

For example, the processing module 703 may be configured to further establish a link of the push message in the blank loading area when the push message is displayed in the blank loading area.

The processing module 703 may be further configured to open an application or a page correpsonding to the link when the link is detected as being initiated.

For example, the processing module 703 may be further configured to cacluate a time for loading the new content, and perform an operation of displaying the push message in the blank loading area if the time is greater than or equal to a preset value.

The methods for displaying a push message according to embodiments of the present disclosure may be implemented by a terminal device. In practical applications, the terminal device may include mobile phones, computers, digital broadcast terminals, messaging devices, gaming consoles, tablets, PDAs, medical devices, exercise equipment, personal digital assistants, and the like.

The terminal device includes one or more processors, such as a computer processor or microprocessor as known in the industry to receive various data, programs and instructions, and to process such data, programs and instructions accordingly. The terminal device may also include a memory which is coupled to the one or more processors and is configured to store the data, programs and instructions to be processed by the processors.

Furthermore, the terminal device may further include input modules, such as a touch screen, a keyboard, a mouse or the like to receive requests and inputs from the user. These are not described in details as they would be readily apparent to those skilled in the art.

Those skilled in the art may appreciate that all or a part of steps in the above embodiments may be implemented by a hardware or may be implemented in a related hardware instructed by instructions stored in a non-transitory computer readable storage medium. The computer can also include the terminal device as defined in the present disclosure.

The non-transitory computer readable storage medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory of the terminal.

The aforementioned methods can be implemented in a non-transitory computer readable storage medium recording computer-readable codes. The non-transitory computer readable storage medium includes all kinds of recording devices in which data readable by a computer system are stored. The non-transitory computer readable storage medium includes ROM, RAM, CD-ROM, magnetic tapes, floppy discs, optical data storage devices, and the like, as well as carrier-wave type implementations (e.g., transmission via Internet).

It is obvious for those skilled in the art that various changes and modifications may be made to the present disclosure without departing from the spirit and scope of the present disclosure. Thus, the present disclosure intends to cover such changes and modifications if those changes and modifications fall within the scope of claims and equivalents thereof in the present disclosure.

What is claimed is:

1. A method for displaying a push message, comprising:
detecting a triggering event for loading a new content;
determining whether a blank loading area exists on a current display page for loading the new content; and
if the blank loading area exists on the current display page, displaying the push message in the blank loading area.

2. The method of claim 1, wherein the push message is received in real time or repeatedly delivered by a server, or stored locally in advance.

3. The method of claim 2, further comprising:
determining whether the push message delivered by the server contains any message subscribed by a user, and, if so, using the message subscribed by the user as the push message to be displayed in the blank loading area.

4. The method of claim 1, wherein displaying the push message in the blank loading area comprises:
sending a request for acquiring a push message to a server;
receiving the push message delivered by the server; and
displaying the push message delivered by the server in the blank loading area.

5. The method of claim 1, further comprising:
establishing a link of the push message displayed in the blank loading area.

6. The method of claim 5, further comprising:
opening an application or a page corresponding to the link when the link is detected as being initiated.

7. The method of claim 1, wherein displaying the push message in the blank loading area comprises:
cacluating a time for loading the new content; and
displaying the push message in the blank loading area if the time is greater than or equal to a preset value.

8. A terminal device, comprising:
a processor; and
a memory for storing instructions executable by the processor;
wherein the processor is configured to execute steps comprising:
detecting a triggering event for loading a new content;
determining whether a blank loading area exists on a current display page for loading the new content; and
if the blank loading area exists on the current display page, displaying the push message in the blank loading area.

9. The terminal device of claim 8, wherein the push message is received in real time or repeatedly delivered by a server, or stored locally in advance.

10. The terminal device of claim 9, wherein the processor is further configured to execute a step of determining whether the push message delivered by the server contains any message subscribed by a user, and, if so, using the message subscribed by the user as the push message to be displayed in the blank loading area.

11. The terminal device of claim 8, wherein displaying the push message in the blank loading area comprises:
sending a request for acquiring a push message to a server;
receiving the push message delivered by the server; and
displaying the push message delivered by the server in the blank loading area.

12. The terminal device of claim 8, wherein the processor is further configured to execute a step of establishing a link of the push message displayed in the blank loading area.

13. The terminal device of claim 12, wherein the processor is further configured to execute a step of opening an application or a page corresponding to the link when the link is detected as being initiated.

14. The terminal device of claim 8, wherein displaying the push message in the blank loading area comprises:
cacluating a time for loading the new content; and
displaying the push message in the blank loading area if the time is greater than or equal to a preset value.

15. A non-transitory computer readable storage medium, which storing instructions which when executed perform a method in a terminal device, the method comprising:
detecting a triggering event for loading a new content;
determining whether a blank loading area exists on a current display page for loading the new content; and
if the blank loading area exists on the current display page, displaying the push message in the blank loading area.
